(19) United States
(12) Patent Application Publication
(10) Pub. No.: US 2010/0042848 A1
(43) Pub. Date: Feb. 18, 2010

(54) Personalized I/O Device as Trusted Data Source

(75) Inventor: Douglas K. Rosener, Santa Cruz, CA (US)

Correspondence Address: PLANTRONICS, INC.;IP Department/Legal, 345 ENCINAL STREET, P.O. BOX 635, SANTA CRUZ, CA, 95060-0635, US

(73) Assignee: Plantronics, Inc., Santa Cruz, CA (US)

(21) Appl. No.: 12/191,263

(22) Filed: Aug. 13, 2008

(51) Int. Cl. H04L 9/32

(52) U.S. Cl. 713/184; 726/19

(57) ABSTRACT

Personalized input/output (I/O) device as trusted credential source is described. According to one exemplary embodiment of the invention, a personalized I/O device used as trusted credential source is configured with a personalized certificate that includes a combination of the user and device information. One or more user credentials are signed with the private key associated with the personalized certificate and sent to an authenticator. An optional secure link based on personalized certificate provides additional security for transmitting the credentials either signed or unsigned. User credentials may include biometric measures (something the user is) such as user's voiceprint sample or fingerprint sample, and passwords (something the user knows). When the user credentials must be originated from the personalized I/O device (something the user has), all three factors of authentication can be included.

### CROSS-REFERENCE TO RELATED APPLICATIONS

This application is related to pending patent application Ser. No. 12/060,031 for “User authentication system and method”, filed on Mar. 31, 2008, the entire disclosure of which is incorporated herein by reference for all purposes.

### FIELD OF THE INVENTION

The present invention generally relates to data source trustworthiness, and more particularly to an input/output (I/O) device used as a trusted credential source in secure transactions remotely.

### BACKGROUND OF THE INVENTION

For the purposes of this disclosure, authentication can be understood to be the act of proving to a computer-based system (known as an authenticator) that a user is who she or he claims to be. User authentication is often described in terms of three factors:

Something the user knows

Something the user is or does

Something the user has.

Authentication is the process of verifying one or more of these factors. A factor submitted to an authenticator is called a credential or user credential.

FIG. 1A shows an authentication process of checking something the user knows (e.g., a password, pass-phrase, personal identification number (PIN)). A user 105 requests authentication via a client computer 110. In response to the authentication request, an authenticator 120 asks the user to enter a password. The user 105 enters the password which is forwarded to the authenticator 120. The entered password is checked against a stored password in a repository of the authentication server 120. If they match, the authentication is granted. Otherwise, the authentication is denied.

A second authentication process of checking something the user is or does (e.g., fingerprint, retinal pattern, DNA sequence, signature, voiceprint sample) is shown in FIG. 1B, in which biometric measures of a user 105 is checked at an authenticator 120 via a client computer 110.

Lastly, FIG. 1C shows yet another authentication process of checking something the user has, also referred to as a token (e.g., cellular phone, access/electronic key, ID card, etc.). These three factors may be included in various combinations for authentication. For example, a password and a biometric measure may be required in one case, while a biometric measure and a token are required in another case.

In a secure transaction (e.g., Automated Teller Machine (ATM) banking, gas station purchase, online commerce, etc.), one or more of the aforementioned authentications is generally required before conducting any transactions. However, there are problems with the prior art approaches.

Password, biometric measure data or token may be stolen or compromised, a perpetrator may gain access as a result. Also, although the token is often associated with a user, this is not usually checked or required for authentication (e.g., a person can use someone else's credit card at a gas station or an online purchase, or someone else's cell phone for a one time password). Additionally, tokens are typically not assigned or reassigned to users remotely, and when they are, it is often not done securely. Finally, with the advent of the Internet and technologies, data (e.g., password) received from a remote source may be altered in transit between the user and the authenticator or the data itself may not be coming from the expected source. Users or consumers of the data need to have a means to determine the authenticity and integrity of the data, and in particular, credentials used to gain access.

One prior art approach to solve this problem is to analyze the data to detect any traces left from alterations, however, the detection becomes more difficult when the tool and the people have become so sophisticated to conceal changes. Another solution is to have a witness when data is created then put into a sealed physical container. Not only does this solution require very high costs, also it may not be feasible for creating data on remote or wireless devices. Additionally, data may be digitally signed at creation to ensure no alteration thereafter as well as providing a traceable source. This method guarantees that the data has not been altered from the sender, and provides evidence that the sender is who they say they are (use of digital signature requires knowledge/control of secret keys and usually traceable to trusted sources). Digital signing works as long as the sender is in control of the signature, and data cannot be corrupted before getting to the secure connection. However, often, secure connections are made between a non-user-controlled I/O device (credential reader) and a secure server (e.g. ATM machine to bank server). The reader must therefore be hardened against physical and electronic attack (costly) to prevent data corruption. For remote connections such physically hardened readers are not feasible for cost and convenience. Also, consumers commonly connect securely using browser software on a general purpose computer and a remote server. The general purpose computer, however, can have malicious software that can monitor and capture passwords, biometric data, and token IDs before they get to the secure connection. Finally, a malicious user in control of one or more credentials of another user could substitute their own token at enrollment time and pretend to be another user.

It would be desirable, therefore, to have improved systems and methods of assuring a trusted credential source used in a remote secure transaction.

### BRIEF SUMMARY OF THE INVENTION

Personalized input/output (I/O) device as trusted credential source is disclosed. According to one exemplary embodiment of the invention, an I/O device used as trusted credential source is configured with a personalized certificate that includes a combination of the user and device information. A two-step procedure may be used to create the personalized I/O device. First, the device is pre-installed with a manufacturer (MFR) certificate that contains device information (e.g., manufacturer, model, serial number, Media Access Control (MAC) address, etc.) during the manufacturing process. Then a user or owner of the I/O device can register or personalize the device to include a previously and optionally independent user certificate that contains information of the user (e.g., name, e-mail address, phone number, etc.). The registration or personalization server combines the information from the manufacturer certificate and independent user certificate to form a personalized certificate. In order to ensure the trustworthiness of these digital certificates, each of the certificates might be traceable to a trusted entity (e.g., certification authority (CA)).

The personalized certificate and signing process is based on Public Key. Infrastructure (PKI), a specific example implementation of which is outlined in a group of Internet memoranda known as Request for Comments 3370 (RFC3370). RFC3370 describes the conventions for using several cryptographic algorithms with the Cryptographic Message Syntax (CMS). The CMS is used to digitally sign, digest, authenticate, or encrypt arbitrary message contents.

The certificate is associated with a pair of asymmetric keys—private and public. The private key is used for signing a data object (e.g., a user credential) and kept secret by the owner. A corresponding public key is then used for decrypting the digital signature and verifying the integrity of the object. And the public key may also be used to encrypt digital data intended for the owner of the corresponding private key.

Under PKI, a digital certificate is made containing at a minimum, the public key, the certificate-owner ID and the certificate-issuer ID. The certificate is then signed by the certificate issuer, making it traceable to the certificate authority or CA. It may also contain other information (like user name, validity date).

When signing any document, including certificates, the private key (known only to the source) encrypts (signs) a hash of the document. Hashing is the process of taking a large piece of data and mapping it into an almost unique fixed length of data. Hashing is done because asymmetric key encryption is generally more computationally intensive than shared key encryption. The encrypted certificate hash can only be decoded using the public key associated with the private key, ensuring the source. The receiver can perform the same hashing algorithm and if the receiver gets the same hash as the decrypted value, the data has not been corrupted. Furthermore, they can apply this process to the embedded signed hash in a certificate, using the public key of the issuer (obtained directly or indirectly from the certificate issuer ID and verify the certificate has not been corrupted and the public key truly came from this source. The public key of the issuer can be verified by this same process and this can continue to a root trusted source (like Verisign).

According to another aspect of the invention, user credentials may include, but are not necessarily limited to, voiceprint sample, fingerprint sample, other biometric measures (e.g., heart rhythm), password/pass phrase/pass-set, user possessed tokens (e.g., a one-time password generated on the fly, a credit card, etc.). Each user may enroll one or more user credentials with an authenticator (e.g., a bank, a merchant, etc.), in which the user credentials are entered/checked and stored for later authentication. During authentication, one or more user credentials are signed using a private key (e.g., private key associated with personalized certificate and/or manufacturer certificate) of the personalized I/O device before being sent to an authenticator. The authenticator would only trust the received credentials when such credentials are signed and sent from the personalized I/O device. The authenticator can validate that the user/device combination originating the credentials corresponds with the user account being authenticated. Granting of authentication would then be decided by checking whether the received credentials match the stored ones. By signing the credentials, the authenticator can be assured that the credentials are sourced on an associated user I/O device and not false credentials or recordings played back by malicious software originating on a PC or somewhere else.

Additionally, when the user credentials are sent under PKI, a hash is created from each of the user credentials to be sent for authentication using a predetermined hash creation scheme. The hash may then be encrypted using the private key of the personalized certificate for additional security. Once the hash is received at the authenticator, the hash is decrypted with the corresponding public key if the hash has been encrypted. The received hash is then compared with a hash generated from the corresponding user credential stored in a credential database. The generated hash is based on the same hash creation scheme, which may be identified in the received certificate or a predetermined secret method. When the received hash matches the generated hash, the credentials are then trusted for further evaluation.

Moreover, an optional secure link is created between the personalized I/O device and the registration, enrollment, or authentication servers for a remote secure transaction. This secure link extends beyond the traditional one for remote transactions, ending at the browser. The secure link is configured to provide additional security for transmitting user credentials hence achieving higher confidence of credential source authenticity because they cannot be easily copied electronically. The secure link may include using any compatible protocol such as HyperText Transfer Protocol over Secure Socket Layer (HTTPS), Internet Protocol Security (IPSec), etc. Alternatively, the secure link may simply comprise of using the personalized certificate on the I/O device and a certificate associated with the authenticator, with each end verifying each other's certificate by tracing the signatures to a trusted source and optionally challenging the other's certificate control by sending a random string and requesting the opposite end to encrypt information with the opposite end's private key. If the certificate is valid and the opposite end is in control of the certificate, then each end can encrypt all further communication with the opposite end's public key.

Further features and advantages of the present invention, as well as the structure and operation of the above-summarized and other exemplary embodiments of the invention, are described in detail below with respect to accompanying drawings in which like reference numbers are used to indicate identical or functionally similar elements.

### BRIEF DESCRIPTION OF THE DRAWINGS

FIGS. 1A-1C are diagrams showing three prior art authentication processes;

FIG. 2A is a diagrams of an exemplary authentication system, in which an exemplary personalized input/output (I/O) device is used as a trusted credential source in a remote secure transaction, according to an embodiment of the present invention;

FIGS. 2B-2F are diagrams showing alternative exemplary authentication systems, in which the personalized I/O device of FIG. 2A in accordance with other embodiments of the present invention;

FIG. 3 is a diagram showing various user credentials may be used in a user authentication process, according to one embodiment of the present invention;

FIG. 4A is an illustration of a headset (an exemplary I/O device) in accordance with one embodiment of the present invention;

FIG. 4B is a functional block diagram showing salient components of the headset of FIG. 4A;

FIG. 5 is a diagram illustrating various stages in creation of an exemplary I/O device as a trusted credential source, according to an embodiment of the present invention;

FIG. 6A is a diagram showing an exemplary system of registering or personalizing the I/O device, according to an embodiment of the present invention;

FIG. 6B is a diagram showing an exemplary system of enrolling the personalized I/O device to be a trusted credential source, according to an embodiment of the present invention; and

FIGS. 7A and 7B are flowcharts illustrating an exemplary authentication process of a remote secure transaction between a personalized I/O device and a corresponding authentication server, according to an embodiment of the present invention.

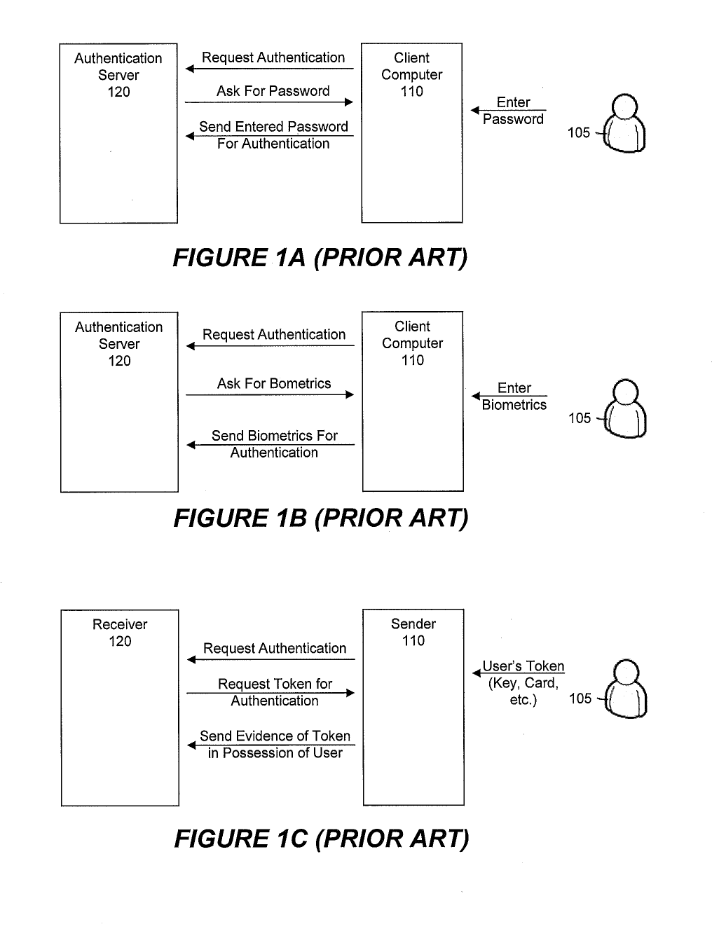

### DETAILED DESCRIPTION

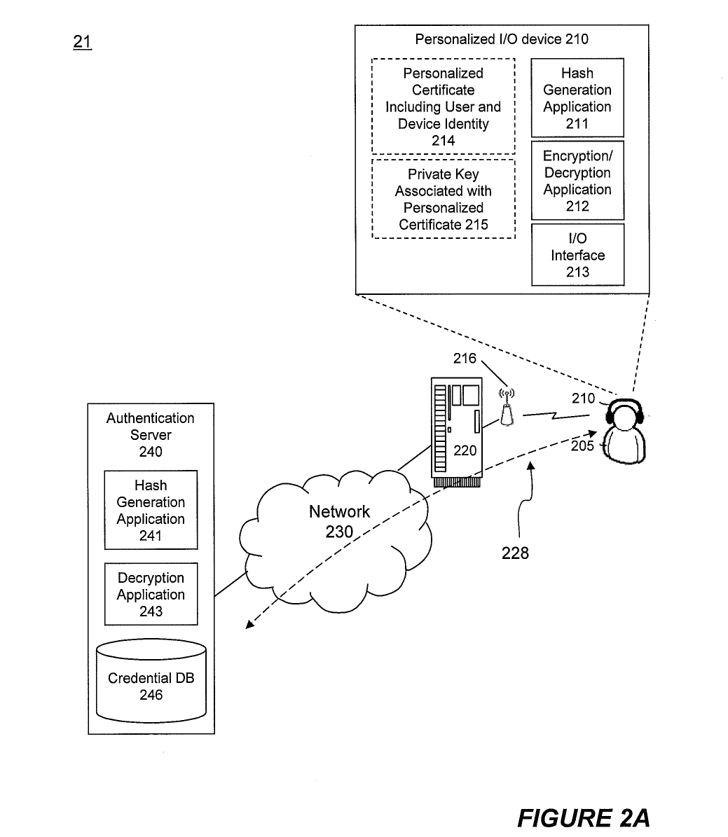

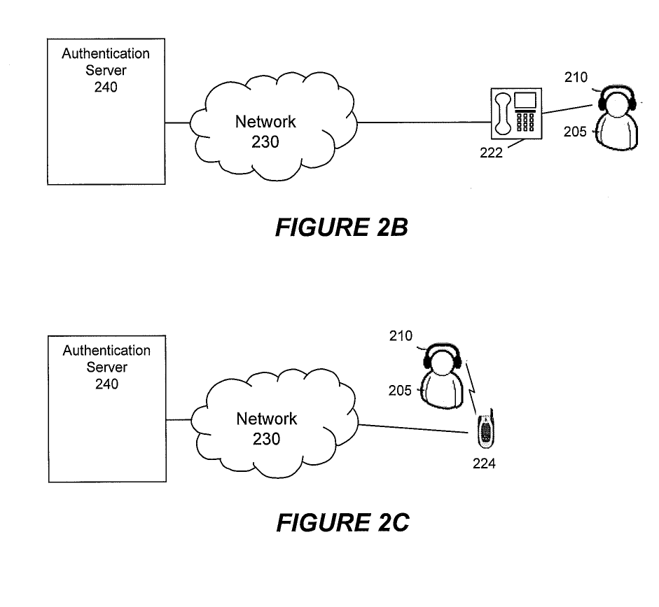

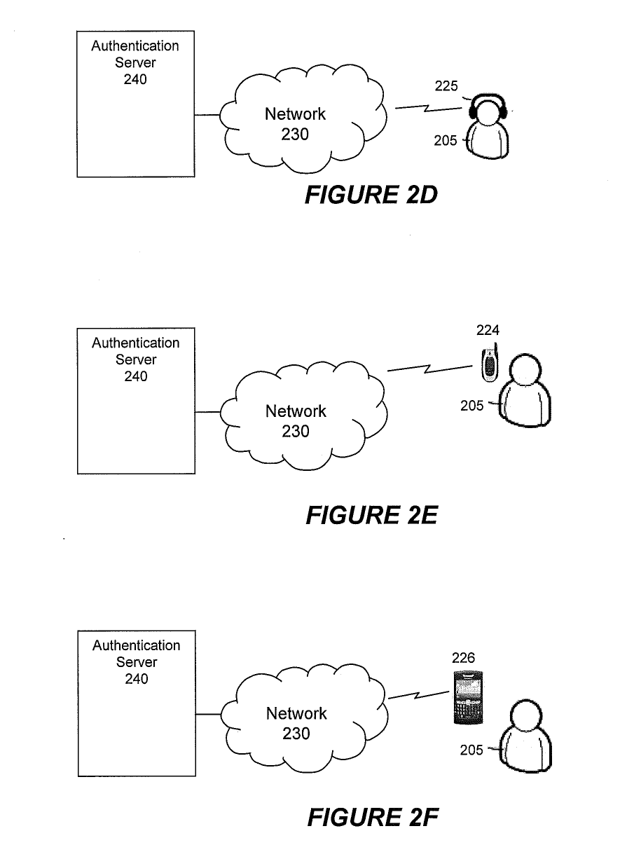

Referring first to FIG. 2A, there is shown an exemplary authentication system 21, in which an exemplary personalized input/output (I/O) device 210 is used as a trusted credential source in a remote secure transaction, according to an embodiment of the present invention. The authentication system 21 comprises an authentication server or authenticator 240, coupled to a data network 230, having a first hash generation application 241, a decryption application 243 and a user credential database (credential DB) 246 installed thereon, a client computer 220, coupled to the network 230, having a wireless base station 216 coupled to thereon and a input/output (I/O) device 210, adapted to be operated by a user 205. The I/O device 210 is configured with a second hash generation application 211, an encryption application 212, a personalized certificate 214 with an associated private key 215, and an I/O interface 213.

In a remote secure transaction, the authenticator 240 is configured to authenticate the user 205 over the data network 230 (e.g., Internet) under public key infrastructure (PKI). The client computer 220 is configured to host a connection of the base station 216, which communicates with the I/O device 210 wirelessly (e.g., Bluetooth). The I/O device 210 (e.g., a headset, a cellular phone, a PDA) is operated by the user 205 through the I/O interface 213, for example, reading in credentials and displaying/playing information to the user 205.

To authenticate the user 205, one or more user credentials are transmitted between the I/O device 210 and the authenticator 240. In order for the I/O device 210 to become a trusted credential source, the I/O device 210 needs to be personalized. In one embodiment, the I/O device 210 is configured with a personalized certificate 214 (under PKI) that contains information of the I/O device 210 and the user 205 combined. The personalized certificate 214 is associated with pubic and private 215 keys. The private key 215 is used for encrypting a hash (i.e., signing a credential) or decrypting data that has been encrypted with its public key (not shown). The second hash generation application 211 is configured to create a hash from a data object (in this case user credential). The second hash generation application 211 may be implemented in firmware, software, hardware or a combination of both. The encryption/decryption application 212 is configured to encrypt the hash with the private key 215. The process of generating a hash from a data object (credential) and encrypting the hash is referred to as digital signing.

The first hash generation application 241 installed on the authentication server 240 is configured to generate a hash of the received credential in the same manner that the second hash generation application 211 creates the hash. In other words, the first and second hash generation applications would create an identical hash from a particular credential. The decryption application 243 is configured to decrypt the encrypted hash using the associated public key (not shown). The credential database 246 is configured to store user credentials that have been securely entered prior to authentication during a procedure called enrollment. During each authentication procedure, one or more user-entered credentials are compared with the stored credentials. If and only if the authenticator 240 determines that the received user credentials are correct and the data source is trusted (i.e., the user 205 enters the credential from a personalized I/O device indicated in the personalized certificate), the authentication server 240 would authenticate the user 205. Otherwise, the authentication would not be granted.

In order to provide additional security for the authentication procedure, an optional secure link or path 228 is established to facilitate the transmission of the signed credentials from the I/O device 210 to the authenticator 240. The secure link 228 can be formed using, for example, PKI, mutually verifying certificates or creating full blown HTTPS connection.

According to another embodiment, a second exemplary authentication system is shown in FIG. 2B. Instead of wireless base station 216 and client computer 220, the headset 210 is coupled to a telephone 222 and then to a data network 230, for example, an Internet Protocol (IP) based Private Branch Exchange (PBX) system. In the exemplary system shown in FIG. 2C, the user 205 uses a cellular telephone 224 with internet connectivity provided by the cellular network along with a personalized headset 210. In yet another embodiment, an intelligent headset 225 shown in FIG. 2D couples to the data network 230 directly via a wireless communication link (e.g., WiFi, WiMax, etc.). Alternatively, the user 205 may enter credentials directed from a personalized cellular phone 225 (FIG. 2E) or a personal digital assistant (PDA) 226 (FIG. 2F).

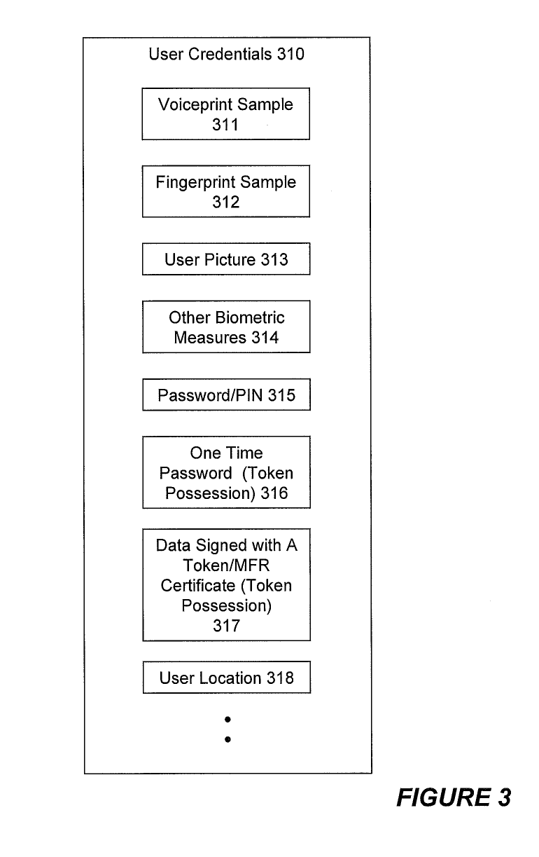

Referring now to FIG. 3, a diagram of user credentials is shown. The user credentials 310 may include, but are not limited to, voiceprint sample 311, fingerprint sample 312, user's digital picture 313 and other biometric measures 314 (e.g., heart rhythm, DNA sequence, etc.), password, pass-phrase or PIN 315, one time password (OTP) 316, data signed with a token 317 and user's location 318. One or more of these user credentials can be used for authenticating a user by an authenticator. The voiceprint sample 311 may be recorded using a microphone and associated hardware/software of the I/O device. The fingerprint sample 312 may be scanned in using a fingerprint sensor and associated hardware/software of the I/O device. The user's picture 313 may be taken using a camera unit of the I/O device. The one-time password 316 can be generated by the I/O device or be sent from the authenticator to the I/O device optionally under a secure link based on either the manufacturer certificate or the personalized certificate.

In order to trust the credential transmitted remotely, the credentials are sent from a personalized I/O device, which controls a personalized certificate that can be traced to a trusted source. Furthermore, the certificate states the user associated with the I/O device and this must agree with the user trying to authenticate. As an example, the voiceprint sample 311 belongs to the user (i.e., something the user is or does), the password 315 is kept secretly by the user (i.e., something the user knows), and the personalized I/O device is owned by the user (i.e., something the user has). All the user matches must agree with the user associated with the personalized credential.

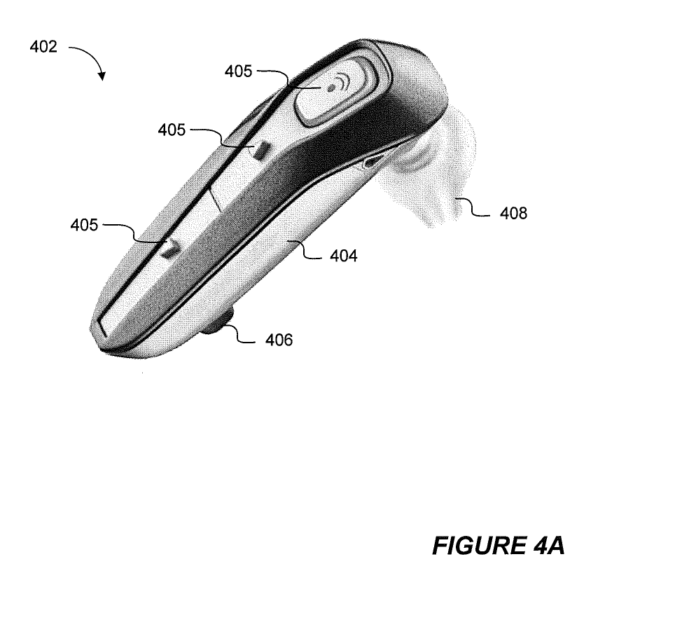

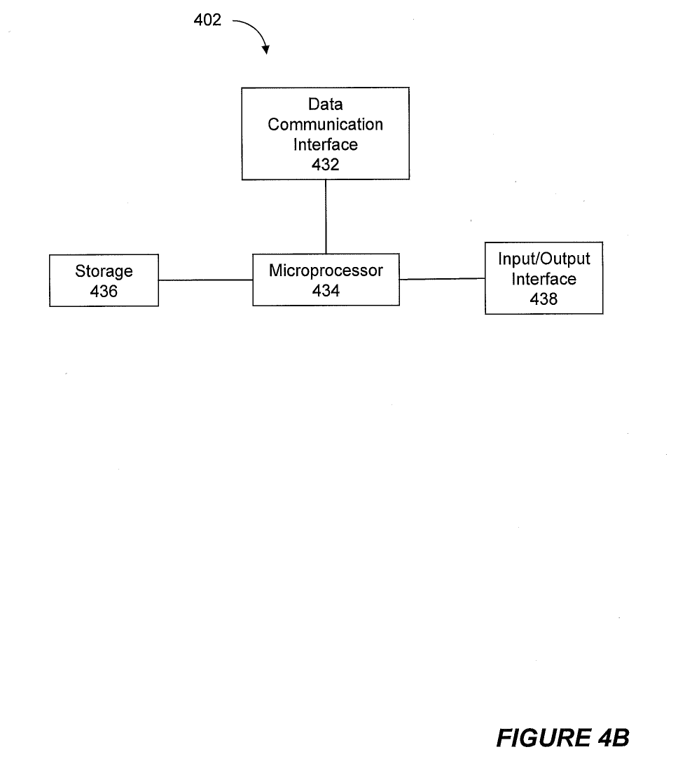

According to one embodiment, an exemplary I/O device is a headset 402 shown in FIG. 4A. The headset 402 includes a body 405, an earpiece 408, a microphone 406 and a plurality of user control buttons 405. A user can enter password via a number of secure entry methods via the headset 402. A voiceprint of the user can be sampled via the microphone 406 of the headset 402, digitally signed and then sent to the authenticator. The user control buttons 405 may be used by the user to manipulate various functions for entering user credentials.

FIG. 4B is a functional block diagram 430 showing salient components of the headset 402 of FIG. 4A. The headset 402 comprises a microprocessor 434, to which a data communication interface 432, a storage device 436, an input/output interface 438 are coupled.

The data communication interface 432 is configured to provide data transmission to and from a remote authenticator. The microprocessor 434 with a digital signing (i.e., hash generation and encryption) application installed thereon is configured to create a unique identification that includes combined information of the I/O device and of the user or owner of the I/O device. The microprocessor 434 is also configured to execute instructions of the application module. The storage device 436 is configured to provide storage for the microprocessor 434 and to store personalized certificate. The storage device 436 may comprise random access memory (RAM), read-only memory (ROM), flash memory, hard disk drive or other equivalent storage devices that can provide storage in the headset 402.

The input/output (I/O) interface 438 is configured to facilitate a user to enter one or more user credentials. The I/O interface 438 may comprise a variety of switches, buttons and other controls, for example, mechanical button, slide switch, touch sense control, mouse, keyboard, microphone, motions sensor (nodding head for yes), camera, biometric scanners or other interfaces that allow the user to enter credential or enable the user credentials be retrieved. The I/O interface 438 may also comprise a variety of visual, and audio, tactile and other output devices, for example, liquid crystal display, speakers, or vibrate motor. These can provide the user with one-time passwords, alerts to enter credential, or provide menus for control of credential entry.

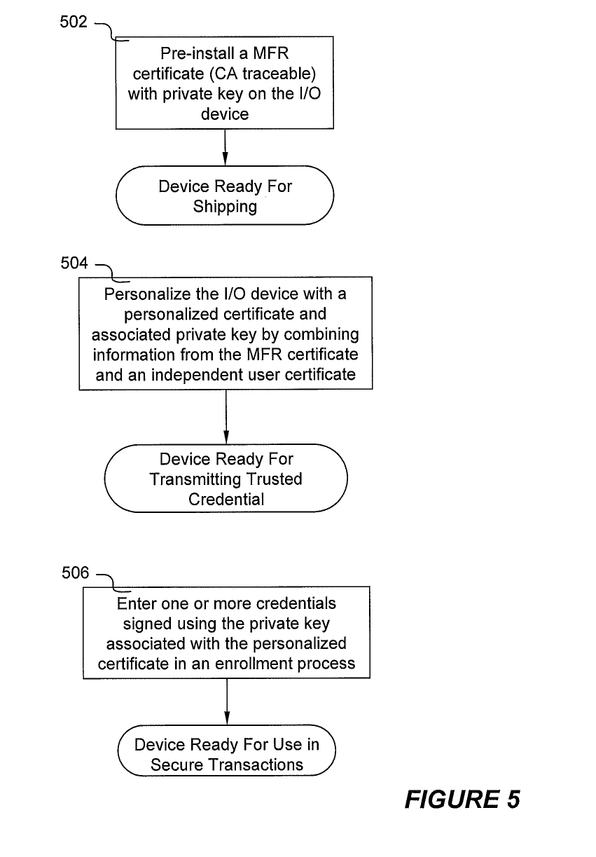

Before becoming a trusted credential source, the I/O device is configured using a two-step process shown in FIG. 5, according to one embodiment of the present invention. First at step 502, an I/O device (e.g., headset 402) is pre-installed with a manufacturer (MFR) certificate, which is preferably traceable to a certification authority (CA) to increase trustworthiness level in an authentication. The MFR certificate contains information of the I/O device such as manufacturer identification, model, serial number, MAC address, etc. The MFR certificate is associated with a pair of MFR public and private keys according to the PKI. The I/O device is ready for shipping and may be purchased by a consumer/user. Second at step 504, the I/O device is personalized in a device registration or personalization procedure after the user/consumer has purchased or owned the device. During the registration procedure, a CA traceable independent user certificate is required (often stored on one or more of the user's PC). Information of the user (e.g., user name, e-mail address, phone number, etc.) is generally included in the independent user certificate. The user and device information are then combined and included in a personalized certificate to be configured into the personalized I/O device.

The registration or personalization procedure is generally performed by a registration authority which can be the manufacturer or another trusted third party. It is noted that generation of the personalized certificate requires the private key associated with the MFR certificate (typically stored with the device) as well as the private key associated with the independent user certificate (known to the user). As a result of the two-step process, the source of user credentials and other data originated from the personalized I/O device can be identified and traced, and thereby trusted. The registration may be performed online, with the user demonstrating ownership of the user certificate through the browser using standard personal computer (PC)/Internet protocols, and the device itself demonstrating ownership of the manufacturing certificate automatically by signing random numbers originated by the registration server. The registration process may also be performed in an out-of-band manner (e.g., user submits credentials, device to be personalized and certificated in person to an agent for the registration authority).

Additionally, in order to use the personalized I/O device in secure transactions remotely, an enrollment procedure is needed at step 506. In the enrollment procedure, one or more user credentials are stored in a user credential database for later authentication. In this embodiment, one or more user credentials should be signed by the personalized I/O device to ensure the authenticity, however this may not be a requirement in other embodiments. Like registration, enrollment can be done in person as well as online.

The online transmission of the user credentials during enrollment or authentication is conducted using PKI, in which a hashing process (i.e., hash generation) is performed to transform each of the one or more user credentials into a hash. The hash is then encrypted using a private key (e.g., private key associated with the personalized certificate or with the MFR certificate). Encrypting the hash is optional if a secure link that is formed using PKI for example has been established to facilitate the transmission. Enrollment server receives the hash or encrypted hash along with the corresponding user credential. The enrollment process may also be performed in an out-of-band manner (e.g., submit user credentials in person to an agent for the authenticator). The credentials are then stored into the credential database only if the enrollment server verifies that the received hash matches a hash generated from the received user credential. Each of the stored credentials is associated with the user corresponding to the personalized certificate (i.e., unique personalized I/O device). If desired, the certificate can also be stored at this time for later use during authentication.

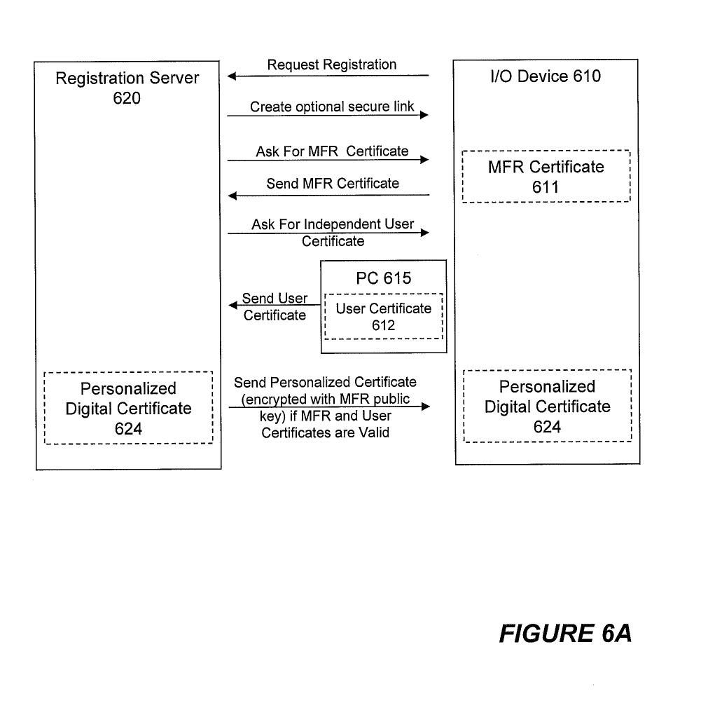

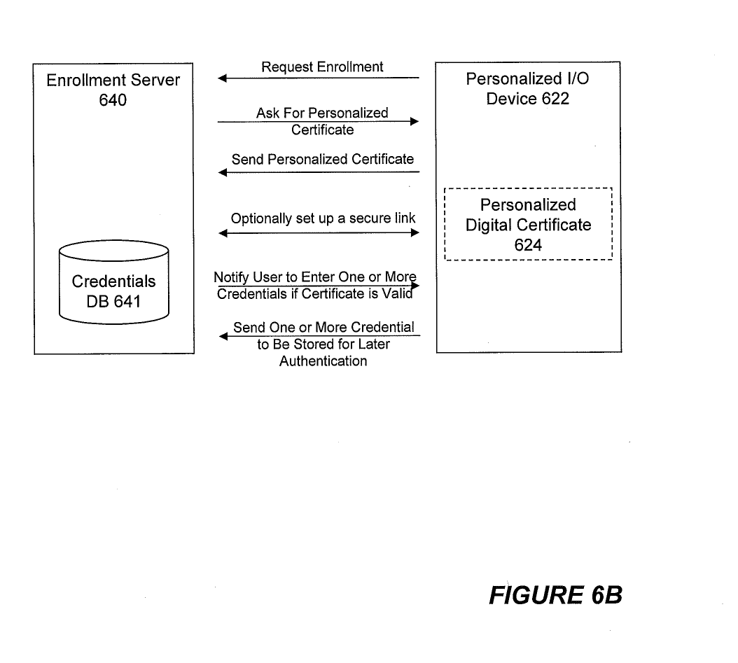

FIG. 6A is a diagram showing an exemplary system of personalizing or registering the I/O device, according to an embodiment of the present invention. The I/O device 610 is preinstalled with a manufacturer (MFR) certificate 611 which includes a MFR private key and a MFR public key (not shown). The MFR certificate 611 is traceable to a trusted source (i.e., a certification authority (CA)). The user requests registration or personalization to a registration server 620. In response to the request, the server optionally sets up a secure link and asks for a manufacturer (MFR) certificate 611. The manufacturer certificate 611 is sent to the registration server 620 with evidence that the I/O device 610 registering is in control of the certificate (e.g., it digitally signs a random data generated by the registration server 620). The registration server 620 then asks for an independent user certificate 612 (typically stored on a PC 615), which is in turn sent to the registration server 620 with evidence that the user registering is in control of the certificate (e.g., the PC digitally signs a random data generated by the registration server). The independent user certificate 612 is also issued from a CA (may or may not be the same CA for the MFR certificate). Because both the MFR and independent user, and personalized certificates are traceable using existing technology (i.e., PKI), any enrollment/authentication site coupled to the Internet can be used for enrolling the personalized I/O device.

After verifying the certificates, the registration or personalization server 620 combines the device and user information from the respective MFR and independent user certificates to create a personalized certificate 624, which is sent back to the I/O device 610 along with an associated private key. The newly generated personalized certificate and private key may be encrypted with a public key of the manufacturer certificate before sending back. This ensures only the device that has the corresponding private key can decrypt and receive the personalized certificate and associated private key. With the combination in the personalized certificate and associated private key, the I/O device 610 can be used as a trusted credential source.

According to one embodiment, an exemplary enrollment procedure system is shown in a diagram shown in FIG. 6B. A user of the personalized I/O device 622 requests enrollment to an enrollment server 640 initially. In response to the request, the enrollment server 640 optionally sets us a secure link and asks for a personalized certificate 624. Once the certificate 624 has been received and verified to be valid (e.g., a specific combination of user and device). One or more user credentials are then either sent or retrieved to be stored in a credential database 641 coupled to the enrollment server 640. The credentials are either sent signed, or sent using a secure link based on the certificate, or both. The stored user credentials are used for later authentication. In addition to the credentials, the certificate may be optionally stored as well.

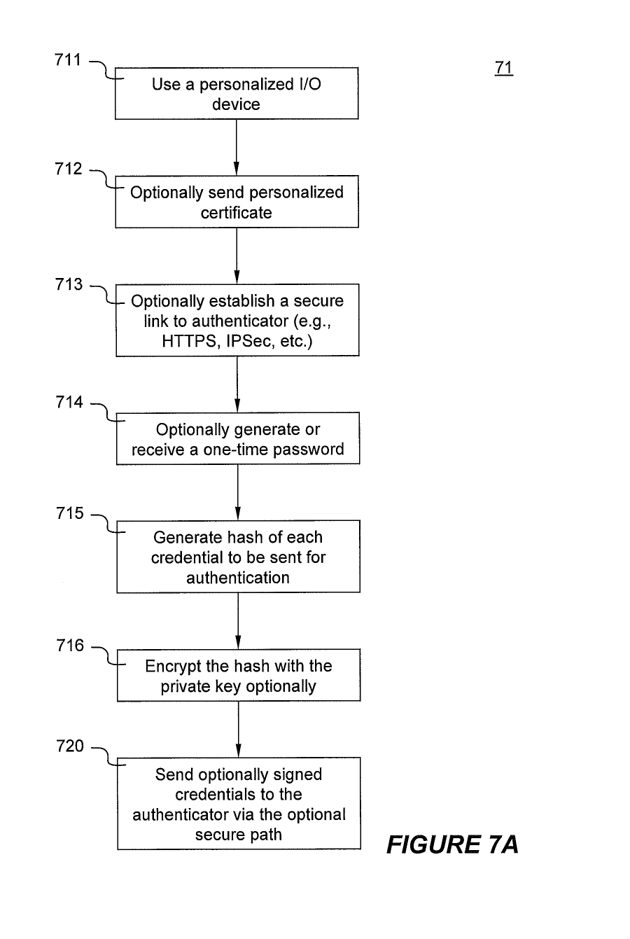

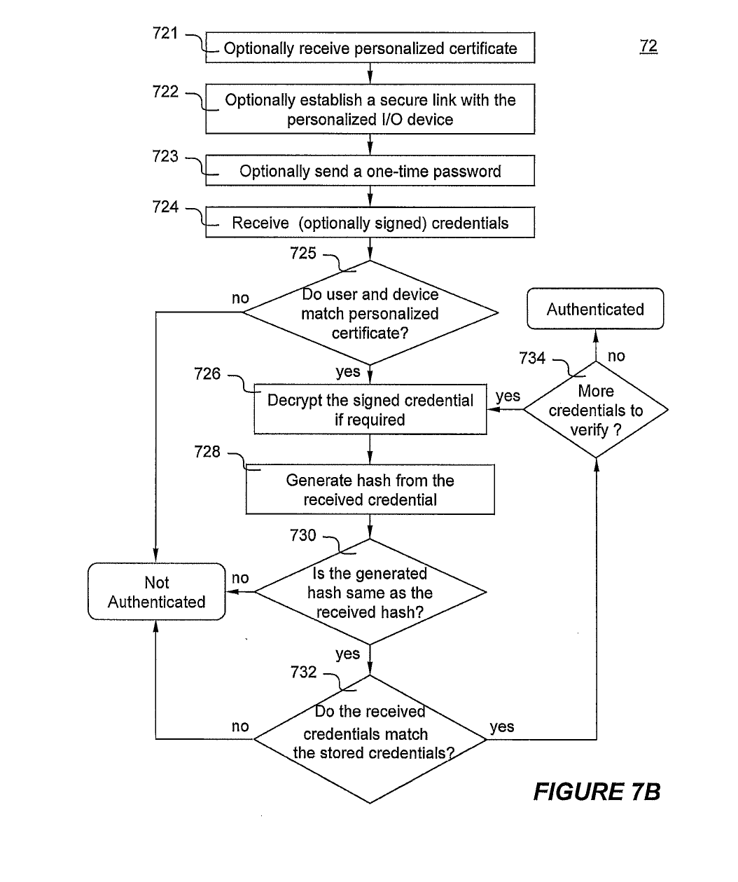

Referring now to FIGS. 7A and 7B, which are flowcharts illustrating an exemplary authentication process of a remote secure transaction between a personalized I/O device 622 and a corresponding authentication server 640, according to an embodiment of the present invention. The personalized I/O device 622 must be already personalized with a personalized certificate 624 that includes information of user and device combined.

The personalized I/O device side of the exemplary authentication process 71 is shown in FIG. 7A. At step 711, the process 71 starts by using a personalized I/O device to conduct the authentication process. Next at step 712, the personalized certificate may be optionally sent to the authenticator in response to the authenticator's request (e.g., request for a certificate or user credentials). In some instances, the personalized certificate has been stored during the enrollment, thereby, no need to send again during the authentication. Then an optional secure link based on the personalized certificate is set up to the authenticator at step 713 (e.g., path 228 of FIG. 2A). The optional secure link may be initiated by either the I/O device or the authenticator. Alternatively, a signed one-time password (e.g., random data originated from the server) may be sent from the I/O device proving possession of the personalized device to the authenticator at step 714. At step 715, a hash is generated from each of the one or more user credentials to be sent for authentication. For example, a hash of a user credential is created by the hash generation application 211 of the personalized I/O device 210 using a predetermined scheme (e.g., Secure Hash Algorithm-1(SHA-1), Message-Digest Algorithm 5 (MD5)).

The hash is then optionally encrypted with a private key (e.g., the private key associated with the personalized certificate) at step 716 to provide additional security when sending over a secure link. However, step 716 is necessary when the credential is sent over a non-secure link. Finally, the hash or encrypted hash is sent to the authentication server 640 preferably through the optional secure link at step 720. Steps 715, 716 and 720 are repeated for each of the required credentials.

The authentication server side of the exemplary authentication process 72 is shown in FIG. 7B. First, the authentication server may receive the personalized certificate at step 721. Then, the secure link or path (e.g., secure link 228) is optionally established with the I/O device 622 at step 722, and/or a one-time password is sent to the I/O device at step 723 for verifying the user's ownership of the I/O device. Signed credentials are received at step 724 via the optional secure link. The authentication server 640 verifies that the user and device are indeed from a trusted source based on the information of the personalized certificate at decision 725. If it is determined that the specific user and device do not match the information on the personalized certificate, the authentication is denied (not authenticated). Otherwise, the process 72 follows the ‘yes’ branch to step 726. If the received hash of a credential is encrypted, the authentication server 640 decrypts the received hash using the associated public key. The public key of the personalized device may be received before credentials are sent, or obtained from a known trusted location (e.g., enrollment server). Then, at step 728, the authentication server 640 generates a hash of the received credential. The generation of the hash is performed with the same scheme used in the I/O device. At decision 730, the received hash is compared with the generated hash. If it is determined that the comparison is not a match, the user is not authenticated. Otherwise, the process 72 follows the ‘yes’ branch to another decision 732. The received credential is then further compared to one stored in the database. If they do not match, the authentication is denied. If ‘yes’ at decision 732, the process 72 moves to decision 734 to determine whether there are more credentials to be check. If ‘yes’, the process 72 moves back to step 726. Otherwise, the authentication is granted.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, while the I/O device has been shown and described as a headset comprising a binaural headphone having a headset top that fits over a user's head, other headset types including, without limitation, monaural, earbud-type, canal-phone type, etc. may also be used. Depending on the application, the various types of headsets may include or not include a microphone for enabling voice recognition. Moreover, while some of the exemplary embodiments have been described in the context of a headset, those of ordinary skill in the art will readily appreciate and understand that the methods, system and apparatus of the invention may be adapted or modified to work with other types of head-worn electronic devices such as personal heads-up display device or a haptic device that vibrates choices. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A personalized input/output (I/O) device as trusted credential source, comprising:
an I/O interface configured to transmit one or more user credentials from a user or owner of the I/O device to an authenticator; and
a personalized certificate configured on the I/O device containing combined information of the user and the I/O device, wherein the personalized certificate is traceable to a trusted source.

2. The I/O device of claim 1, further comprising:
a microprocessor configured to execute instructions from at least one application module installed thereon; and
a memory device configured to provide storage space for said microprocessor and to store said personalized certificate.

3. The I/O device of claim 2 wherein said at least one application module is configured to digitally signing said one or more user credentials with a private key in accordance with Public Key Infrastructure (PKI).

4. The I/O device of claim 3 wherein the private key is used for encrypting a hash generated from each of said one or more user credentials.

5. The I/O device of claim 3 wherein the private key is associated with the personalized certificate.

6. The I/O device of claim 2 wherein said personalized certificate is created with combined information from a manufacturer certificate and an independent user certificate.

7. The I/O device of claim 6 wherein the manufacturer certificate is pre-installed on the I/O device to contain the device information including manufacturer name, model, serial number, and wherein the manufacturer certificate is traceable to a trusted source.

8. The I/O device of claim 6 wherein the independent user certificate contains the user information including name, e-mail address, and wherein the independent user certificate is traceable to a trusted source.

9. The subject matter claimed in claim 1 wherein the I/O device comprises a personalized headset.

10. The subject matter claimed in claim 1 wherein the I/O device comprises a personalized cellular phone.

11. The subject matter claimed in claim 1 wherein the I/O device comprises a personal digital assistant.

12. A method of authenticating a user or owner of an input/output (I/O) device, comprising:
requesting and receiving one or more user credentials entered by the user via the I/O device;
verifying the received one or more user credentials are traceable to a trusted source, and the received one or more user credentials match previously agreed respective credentials associated with the user; and
receiving a personalized certificate that contains combined information of the user and the I/O device.

13. The method of claim 12, further comprises receiving a hash of the received one or more user credentials generated by the I/O device and generating a hash of the received one or more user credentials using same algorithm used by the I/O device.

14. The method of claim 12, further comprising establishing a secure link based on a device certificate between the I/O device and the authenticator, wherein the device certificate is either a manufacturer certificate or a personalized certificate.

15. The method of claim 14 wherein the one or more user credentials are digitally signed with a private key associated with the device certificate.

16. A method of personalizing an input/output (I/O) device such that the I/O device can be used to transmit trusted user credentials, the method comprising:
installing a manufacturer certificate on the I/O device by a manufacturer of the I/O device, wherein the manufacturer certificate contains information of the I/O device; and
creating a personalized certificate on a registration server by combining the information of the I/O device and information of a user or owner of the I/O device, wherein the information of the user is included in an independent user certificate that has been gathered along with the manufacturer certificate during a registration procedure.

17. The method of claim 16 wherein creating the personalized certificate on the registration server further comprises:
requesting and receiving the manufacturer certificate in response to a request for registration, wherein the manufacturer certificate is digitally signed; and
requesting and receiving the independent user certificate after the manufacturer certificate has been received and verified to be valid and trusted.

18. The method of claim 17, further comprising creating a secure link based on the manufacturer certificate between the registration server and the I/O device.

19. The method of claim 17 wherein the independent user certificate is configured on a personal computer and is traceable to a trusted source.

20. The method of claim 16, further comprising encrypting the personalized certificate and associated private key with a public key belonging to the user on the registration server and sending the encrypted personalized certificate to the I/O device when both said manufacturer certificate and said independent user certificate have been verified to be valid and trusted.
